(19) United States
(12) Patent Application Publication
(10) Pub. No.: US 2010/0136405 A1
(43) Pub. Date: Jun. 3, 2010

(54) BATTERY PACK WITH OPTIMIZED MECHANICAL, ELECTRICAL, AND THERMAL MANAGEMENT

(76) Inventors: Karl Johnson, San Francisco, CA (US); Paul Durkee, San Francisco, CA (US)

Correspondence Address: SCHOX PLC, 500 3rd Street, Suite 515, San Francisco, CA, 94107, US

(21) Appl. No.: 12/623,346

(22) Filed: Nov. 20, 2009

Related U.S. Application Data
(63) Continuation-in-part of application No. 12/417,624, filed on Apr. 2, 2009.
(60) Provisional application No. 61/116,559, filed on Nov. 20, 2008.
(60) Provisional application No. 61/116,590, filed on Nov. 20, 2008.
(60) Provisional application No. 61/155,774, filed on Feb. 26, 2009.
(60) Provisional application No. 61/041,848, filed on Apr. 2, 2008.
(60) Provisional application No. 61/052,913, filed on May 13, 2008.
(60) Provisional application No. 61/116,551, filed on Nov. 20, 2008.

(51) Int. Cl. H01M 10/50; H01M 6/00

(52) U.S. Cl. 429/120; 29/623.1

(57) ABSTRACT

Disclosed is a multi-cell battery pack system with integrated thermal and electrical management that includes a plurality of cells, a plurality of cradles that each define a channel that extends through the length of the cradle and having an external surface that mechanically positions each of the cells radially around and parallel to the channel, that exchanges heat with the cells and that electrically couples with each of the cells, and an endplate that, when the cradle is mechanically coupled to the endplate, the channel of the cradle is connected to a fluid circuit that routes thermally conductive fluid through the channel to exchange heat with the channel and the cells are connected to an electrical circuit.

### CROSS-REFERENCE TO RELATED APPLICATIONS

This application claims the benefit of U.S. Provisional Application Nos. 61/116,559 filed 20 Nov. 2008 and 61/116,590 filed 20 Nov. 2008 and 61/155,774 filed 26 Feb. 2009. This application is also a continuation-in-part application of U.S. patent application Ser. No. 12/417,624 filed 2 Apr. 2009, which claims the benefit of U.S. Provisional Application No. 61/041,848 filed 2 Apr. 2008, U.S. Provisional Application No. 61/052,913 filed 13 May 2008, and U.S. Provisional Application No. 61/116,551 filed 20 Nov. 2008. The one patent application and six provisional applications are incorporated in their entirety by this reference.

### TECHNICAL FIELD

This invention relates generally to the power source field, and more specifically to an improved power source and method of managing a power source.

### BACKGROUND

As the market for applications that require large amounts of portable electrical power grows, the need for efficient, safe, reliable, and high power density battery packs increases. In particular, electrically powered vehicles, such as passenger vehicles, all-terrain vehicles, motorcycles, and scooters, require exceptionally high levels of power density to enable the vehicle to have a travel distance per charge that is comparable to present day gasoline powered vehicles. Within the class of mass produced batteries, lithium ion batteries have one of the highest energy densities. These batteries, which are most commonly used in laptop computers, are the most cost-effective in a relative small form factor. To create a suitable power supply for electrical transportation needs, relatively large numbers of these cells (on the order of hundreds or even thousands) must be grouped together. With such a large number of cells, thermal and electrical management becomes very critical for efficient, safe, and reliable performance.

The lithium ion batteries are available in two general varieties: “power” and “energy”. Power cells can provide higher power bursts for shorter time durations, while energy cells can provide greater total energy, but lower power, over longer time durations. In order to combine the advantages of high power and greater total energy available, it is desirable to manipulate an energy cell to occasionally release higher power bursts. This manipulation, however, produces a large amount of heat. Due to the specific cell chemistry of a lithium ion cell, if a substantial amount of current is pulled from the cell, and the heat is not dissipated quickly away from the cell, the cell will generate significant heat. The generated heat may shorten the working life of the cell and, under certain situations, could cause catastrophic cell failure. In addition, relatively cold temperatures (for example, winter conditions) cause the specific cell chemistry of a lithium ion cell to yield a less efficient power output. Keeping the cells within a specific operating temperature range (which conventionally requires cooling) is challenging, especially when there are numerous cells in close proximity to each other.

There are, unfortunately, even further challenges with battery packs that have a large number of lithium ion cells, such as providing electrical connections between the cells with a certain level of electrical and environment isolation (to improve the ability to contain heat and fire in the event of a cell catastrophic failure), and providing the capability of convenient and efficient maintenance of a large number of cells throughout the life of the battery pack is also a challenge.

Thus, there is a need in the field to create a battery pack with optimized mechanical, electrical, and thermal management that facilitates the occasional release of higher power bursts from an energy cell, in an efficient, reliable, and safe manner. This invention provides such an improved structure and arrangement.

### BRIEF DESCRIPTION OF THE FIGURES

FIG. 1 is a detailed representation of a first preferred embodiment of the invention.

FIG. 2 is a detailed representation of the ductors of FIG. 1.

FIG. 3a is a detailed representation of the modules of FIG. 1.

FIG. 3b is a detailed representation of the wrapping of the modules of FIG. 1.

FIG. 4 is a detailed representation of an alternative module of FIG. 1.

FIG. 5 is a detailed representation of the arrangement of the modules of FIG. 1.

FIG. 6 is a detailed representation of the arrangement of the alternative modules of FIG. 1.

FIG. 7 is a detailed representation of a locking mechanism to couple the modules to the endplates of FIG. 1 in a cross sectional view.

FIGS. 8a and 8b are detailed representations of the endplates of FIG. 1.

FIGS. 9a and 9b are detailed representation of the positive and negative contacts, respectively, of the endplates of FIG. 8.

FIG. 10 is a detailed representation of the positive and negative contacts of the endplates of FIG. 8 with a ductor of FIG. 2.

### DESCRIPTION OF THE PREFERRED EMBODIMENTS

The following description of the preferred embodiment of the invention is not intended to limit the invention to these preferred embodiments, but rather to enable any person skilled in the art to make and use this invention.

### 1. Summary of the Battery Pack

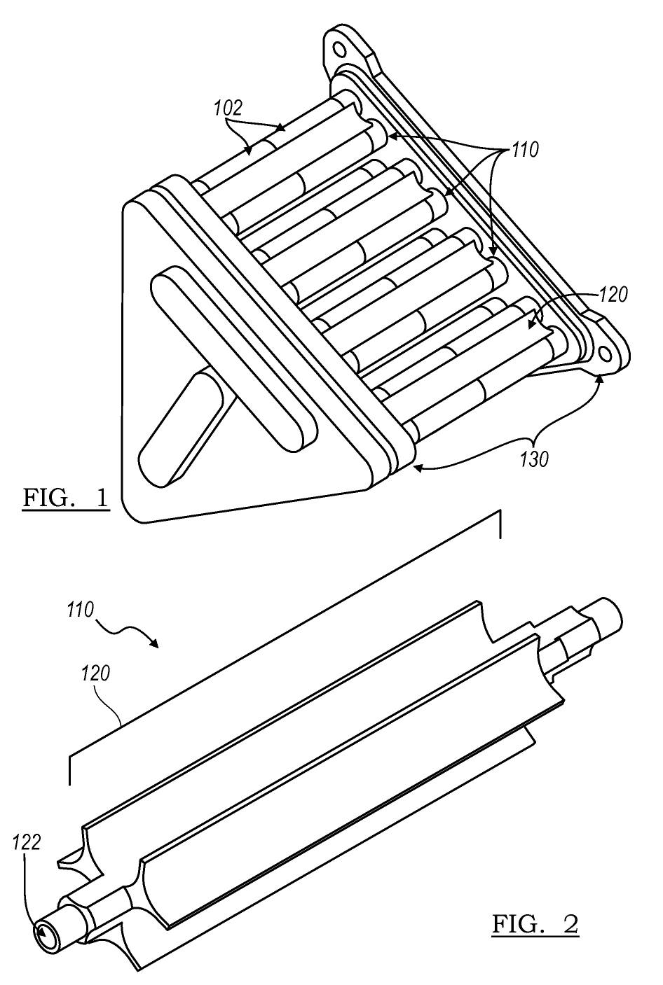

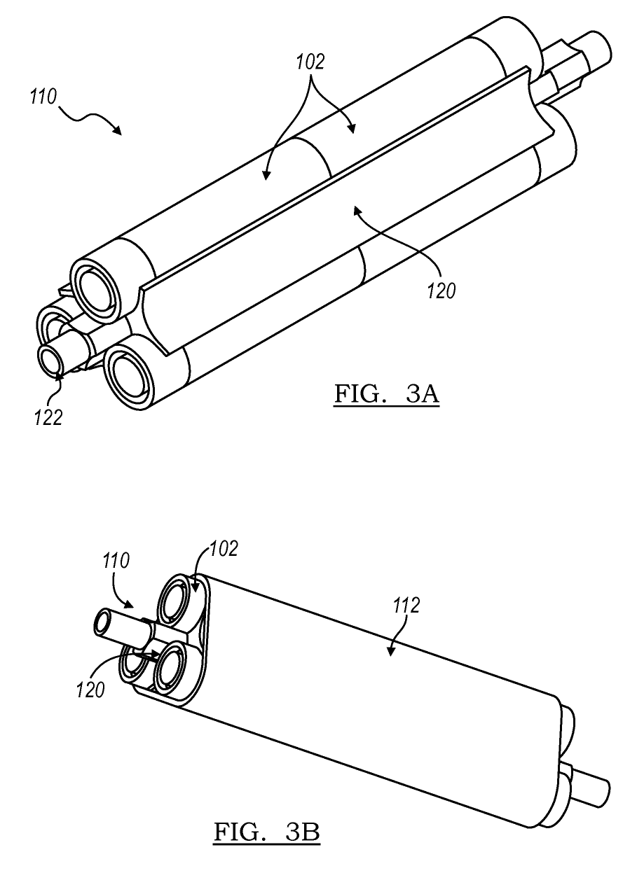

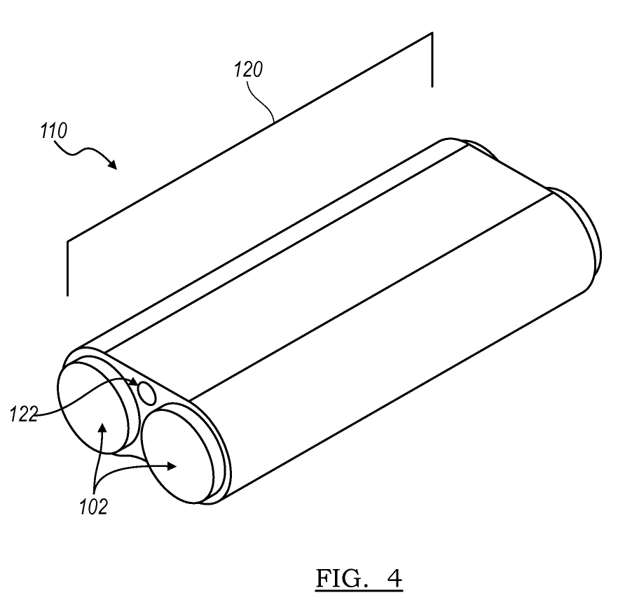

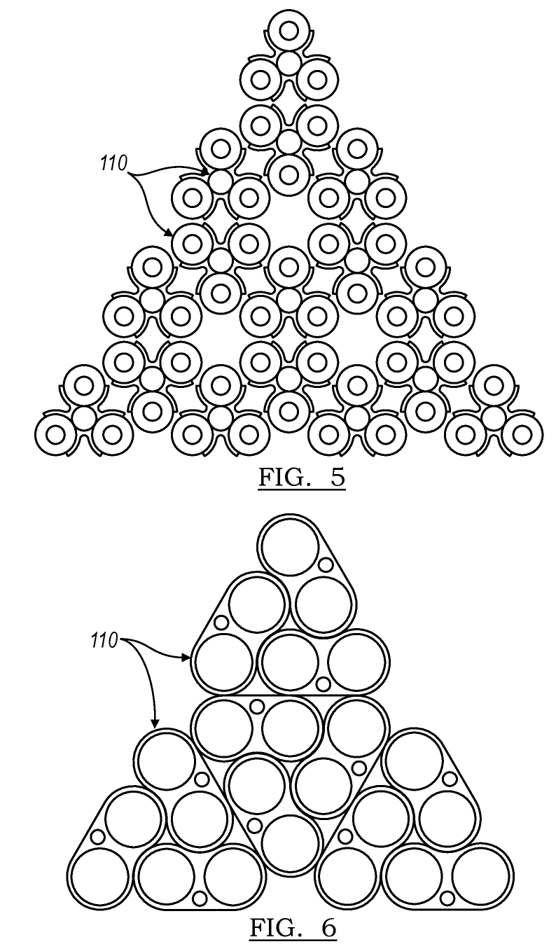

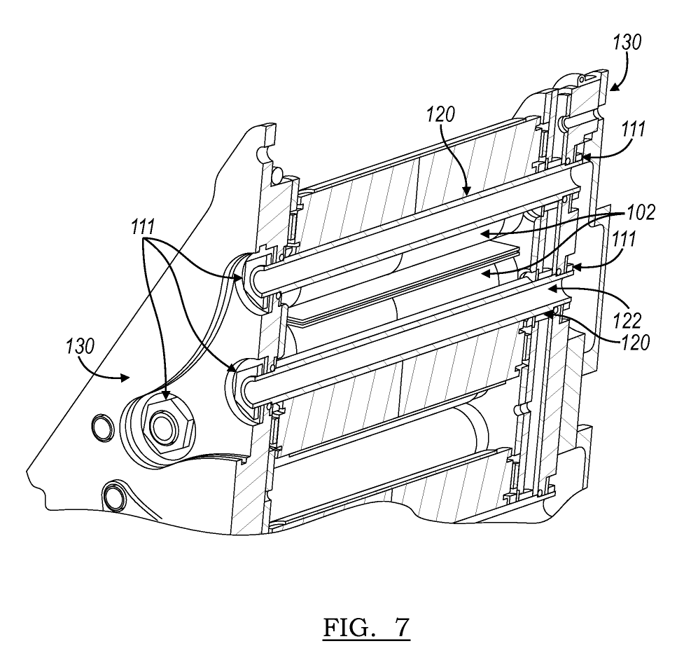

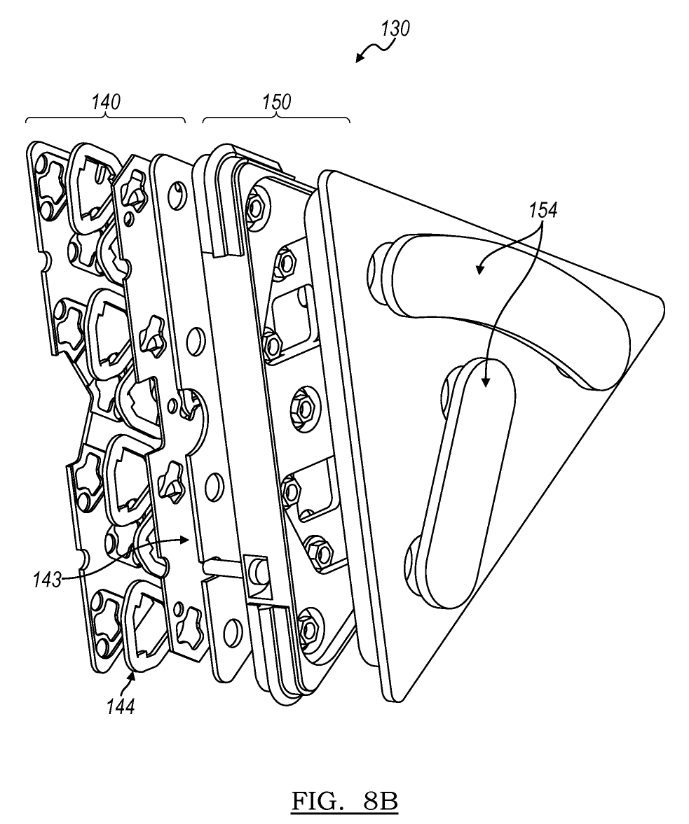

As shown in FIG. 1, the battery pack of the preferred embodiments includes a module level and an integration level. The battery pack of the preferred embodiments is preferably connected to a fluid circuit of a thermal management system that utilizes a thermally conductive fluid as the heat transfer medium. The thermal management system preferably includes a source of thermally conductive fluid and preferably manages the thermal conditions within the battery pack. The battery pack of the preferred embodiments is preferably also connected to an electrical circuit managed by an electrical management system to power a device. The electrical circuit may also include a plurality of other battery packs. As shown in FIGS. 2-4, the module level 110 of the battery pack 100 includes a ductor 120, multiple cells 102, and a channel 122 that is an interface to the fluid source of the thermally conductive fluid of the thermal management system. A first geometry of the module 110 is shown in FIGS. 2 and 3 and a second geometry of the module 110 is shown in FIG. 4. On the integration level, as shown in FIGS. 1, 8a, and 8b, the battery pack 100 includes at least one endplate 130, a plurality of modules 110, and a fluid director that is an interface to the fluid source 210 of the thermally conductive fluid of the thermal management system. The integration of the first geometry of the module 110 is shown in FIG. 5 and the integration of the second geometry of the module 110 is shown in FIG. 6. Together, the module level 110 and the integration level cooperate to form a modular and adaptable battery pack 100 that is optimized for mechanical, electrical, and thermal management. The battery pack 100 was specifically designed for lightweight, electrical transportation needs (in, for example, scooters, motorcycles, all-terrain vehicles, and small passenger vehicles) and for lightweight, electrical agriculture and construction needs (in, for example, lawnmowers and forklifts), but may be alternatively implemented in other suitable environments and application. One such suitable application includes the use of the battery pack 100 of the preferred embodiments to efficiently package, house, and thermally regulate solar arrays, fuel cells, or any other grouped commodity. Another such suitable application includes the use of the battery pack of the preferred embodiments to replace diesel or other fuel-fired generators, such as fixed or mobile auxiliary power units.

### 2. Module Level

On the module level 110, as shown in FIGS. 2-4, the battery pack 100 of the preferred embodiments includes a ductor 120, multiple cells 102, and at least one interface to an external fluid thermal management system.

The ductor 120 of the preferred embodiment functions as the mechanical, electrical, and thermal connection for the cells 102. From a mechanical standpoint, the ductor 120 preferably functions to cradle the cells 102 in a radial pattern and an axial orientation (relative to the central fluid channel 122). More specifically, the ductor 120 preferably functions to cradle three cells 102 in a generally triangular shape, but may alternatively function to cradle six cells 102 in a hexagonal shape, six cells 102 in a triangular shape, four cells 102 in a diamond or square shape, or any other suitable number of cells 102 in any suitable geometric shape. The ductor 120 provides surfaces for the cradling of the cells 102 and the transporting of heat. When used with cylindrical cells 102, the surfaces are preferably radiused to provide a large surface area contact with the cells 102. If the invention is used with brick-shaped cells 102 (similar to the cells 102 used in conventional mobile phones or lithium-polymer prismatic cells 102), the surfaces are preferably flat. The battery pack 100 preferably avoids joining cells 102 and modules 110 with permanent glues and fixations, providing ease of repair. The ductor 120 is preferably made from a thermally and electrically conductive material, such as aluminum (and is preferably machined or extruded), but may alternatively be any suitable material.

The multiple cells 102 of the preferred embodiment function to provide the energy of the battery pack 100. The cells 102 of the preferred embodiment directly contact the ductor 120 and, thus, are electrically connected to the ductor 120. In the preferred embodiments, the body and a first end of the cell 102 preferably functions as the negative terminal of the cell 102 the other end of the cell 102 preferably functions as the positive terminal of the cell 102. The ductor 120 preferably mechanically couples to the body of the cell 102 and the positive terminal of the cell 102 is preferably left exposed on either end of the ductor 120 and preferably does not come into contact with the ductor 120. This results in electrically coupling the ductor 120 to the negative terminal of each cell 102 and the positive terminals of each cell 102 to be accessible. In addition to the electrical connection of the ductor 120, the module 110 also includes at least one additional electrical conductor 120 to complete the connection between the cells 102 within the module 110. The cells 102 are preferably arranged in a parallel type electrical connection (shown in FIG. 3a). The arrangement of cells 102 also accommodates for the variation in cell 102 diameter that is present in readily available cells 102 on the market. In a first variation, the multiple cells 102 are preferably lithium ion cells 102 of type number 18650, which have the following specification: Nominal Voltage is 3.6-3.7 V, Shape is cylindrical, Diameter is 18 mm, Length is 65 mm, and Capacity is 2400-2600 mAh. These cells 102, which are lightweight and have a high energy density, are generally used in laptop computers. In a second variation, the multiple cells 102 may be lithium ion cells 102 of type number 26700 (which have the following specifications: Shape is cylindrical, and Diameter is 26 mm, Length is 70 mm) or to incorporate any suitable cells 102 that have a cylindrical shape. In other variations, any suitable cell 102 of greater (or lower) capacities, of greater (or lower) voltages, of larger (or smaller) form factor may be used.

In the preferred embodiment, the fluid of the thermal management system functions to transport heat from the individual cells 102 through the heat ductor 120 and to a remote location. The thermal management system may also function to transport heat from an external heat source 210 through the heat ductor 120 and to the individual cells 102. The module 110 preferably includes a channel 122 that provides a conduit for the flow of the fluid. The size of the channel 122 is preferably optimized for heat transfer relative to flow rate. The ductor 120 is preferably designed such that the fluid of the thermal management system is directed through the center of the ductor 120, allowing the fluid to be equidistant to all cells 102 upon passage through the ductor 120 and providing equal thermal management benefits to each cell 102 located at a particular length along the ductor 120. As the fluid flows through the channel 122, the thermal management benefit experienced by a cell 102 located along a length closer to where the fluid enters the channel 122 may be different from that experienced by a cell 102 located along a length closer to where the fluid exits the channel 122. For this reason, the flow of fluid may be periodically reversed through the channel 122. The ductor 120 may alternatively be designed to provide unequal thermal management benefits to the cells 102, which may be advantageous if the module 110 includes a mixture of both “energy” and “power” cells 102 that produce different amounts of heat and operate under different optimal thermal conditions. To increase thermal transfer, the ductor 120 is preferably made of aluminum or any other thermally conductive material. The channel 122 is preferably defined as a bore in the ductor 120. The channel 122 and other surfaces on the ductor 120 are preferably coated with a hard metal coating such as nickel or zinc that functions to protect the ductor 120 from electroplating and other corrosion due to small electric currents that may result from the fluid flow. Hard metal coating is high in conductivity and may be applied in a thin layer, having little or no detrimental effect on thermal transfer between the cells 102 and the channel 122. Alternatively, the coating may be of a plastic or resin based coating that functions as a protective layer and a dielectric to prevent current from flowing in between neighboring ductors 120 through the fluid. Plastic or resin based coating is very effective in corrosion control, but may introduce resistance to thermal conductivity between the channel 122 and the fluid, and subsequently from the cells 102 to the fluid. The channel 122 may also be a pipe inserted into the ductor 120. The pipe is preferably made of hard metal to achieve similar corrosion prevention with little or no detrimental effect on thermal transfer as a hard metal coating. Alternatively, the pipe may be a plastic or resin based insert. However, any other suitable coating or pipe material may be used to protect the channel 122. The ductor 120 may alternatively have two channels 122, allowing two flow paths to flow through the ductor 120 at one time. The two channel 122 ductor 120 may also include a fluid turnaround element to direct fluid flowing through one channel 122 to turn around and flow through the second channel 122. This may facilitate the implementation of homogenous cooling to the module 110 and be more space efficient.

The thermally conductive fluid of the thermal management system is preferably a working fluid selected based upon properties such as electrical resistivity, specific heat, thermal conductivity, viscosity, boiling and freezing points, and/or chemical stability in the environment of application (for example, the temperature range of the environment, exposure to different materials within the environment, etc). The fluid is preferably water, propylene glycol, or a mixture of propylene glycol and water. The fluid may alternatively be mineral oil, sunflower and canola oil, ethylene glycol, or a mixture of ethylene glycol and water, but may also be any other suitable working fluid. The thermal management system preferably includes a pump that functions to drive the fluid. The pump is preferably capable of driving fluid through the diameter of the module 110 channel 122 at a desired flow rate for the desired heat transfer between the module 110 to the fluid. When removing heat from the module 110, the fluid passes through the module 110 and the heat generated by the cells 102 and transferred to the module 110 from the cells 102 is transferred to the fluid and then removed from the module 110 by the exiting fluid. When adding heat to the module 110, heat from the heat source 210 is transferred to the fluid and is transferred to the cells 102 as the fluid passes through the module 110. The thermal management system also preferably includes a heat dissipater, such as fins, that function to extract the heat from the fluid before the fluid is recycled through the module 110. In colder climates, some or all of the heat extracted during a battery usage cycle is preferably stored and used as a heat source 210 in a future battery usage cycle to bring the temperature of the cells 102 to an optimal operation temperature. Alternatively, the heat source 210 may be an active heating element such as a heat coil.

The module level 110 of the battery pack 100 may also include a wrapping 112 around the perimeter of the cells 102, as shown in FIG. 3b. The wrapping 112 functions to electrically insulate the raw cell 102 bodies from adjoining module 110 cells 102 and to press the cells 102 radially into firm contact with the ductor 120, which preferably provides for maximum heat transfer efficiency and robust electrical connection. The wrapping 112 may alternatively function to substantially seal or hermetically encase the cells 102 of the module 110. A hermetic casing may function to prevent contaminants into and out of the module 110. However, any other suitable wrapping and/or casing may be used.

The module level 110 of the battery pack 100 may also include sensors and processors. The sensors function to measure the operating conditions (such as voltage, current, temperature, and internal resistance) of the individual cells 102 and/or the overall module 110, while the processor functions to determine the optimal mode of the module 110 at the current time: to stay connected, disconnect, or reconnect within the battery pack 100. In the variation where the cells 102 of the module 110 are hermetically encased, the sensors may also function to measure the pressure within the module 110. In the case of catastrophic failure of a cell 102, the pressure of the cell 102 will increase drastically in a short period of time. The pressure sensor within a substantially or hermetically sealed module 110 may detect the sudden increase in pressure and processor may determine that a cell 102 within the module 110 is going through catastrophic failure and may disconnect the module 110 from the battery pack 100, preventing further damage to the battery pack 100. The operating conditions are preferably measured and evaluated in real time, regardless of the connection state of the cell 102. If a cell 102 that has been disconnected is deemed to be healthy and functional, it may reconnect within the battery pack 100. Because of the relatively small percentage of the overall cells 102 in the battery pack 100 that are contained in each module 110, disconnecting and reconnecting modules 110 from the battery pack 100 structure during operation does not have a large impact on the overall performance of the battery pack 100, allowing power output to be steady while continuous maintenance is carried out during operation.

The module level 110 of the battery pack 100 may also include module 110 end caps. The end caps function to integrate the ductor 120, the multiple cells 102, and the electrical circuitry and allow the module 110 unit to function as a standalone unit, which facilitates maintenance and repair. The end caps may also cooperate with a casing or a wrapping to form a hermetic seal around the module 110. The module 110 end cap preferably assembles onto the module 110 to complete the electrical connection between the cells 102, measure relevant data, and provide an electronic connection point to the battery pack 100 that preferably functions to transmit power to and from the cell 102 as well as communicate operating conditions with the rest of the battery pack 100 system. This end cap is preferably isolated from the channel 122. Alternatively, the electronic circuitry may also be embedded into a printed circuit board with probes to measure relevant data that extend into the module 110 and is assembled into a dedicated location on the module 110. This location may be a slot in the module 110 or a location on the surface of the module 110. However, any other suitable electrical circuitry form factor may be used. The electronic circuitry of the preferred embodiment may alternatively be embedded into the integration level (as described below), allowing the module level 110 to remain a relatively simple construction of a ductor 120 and multiple cells 102. In this variation, the ductor 120 and the positive connections of the cells 102 preferably directly contact the module 110 mounting terminals on the integration level and relevant data is measured through components built into the integration level. In this variation, control and intelligent components of the system are preferably contained within the integration level, allowing simple replacement of malfunctioning modules 110 and/or cells 102.

The module level 110 of the battery pack 100 may also include electrical insulators and flame retardant shields that cooperatively function to seal the cells 102 in an environmentally and electrically isolated confinement, which may improve the ability to contain heat, fire, or any other thermal event in the event of a cell catastrophic failure.

### 3. Integration Level

On the integration level, as shown in FIG. 1, the battery pack 100 of the preferred embodiments includes a plurality of modules 110, an endplate 130, and at least one interface to the fluid source 210 of the thermally conductive fluid of the thermal management system. In the preferred embodiments, the battery pack 100 preferably includes two endplates 130, one at either end of the channel 122 of the modules 110.

The battery pack 100 preferably contains sixteen modules 110 (for a grand total of ninety-six cells 102). Each module 110 preferably contains 10% or less of the overall number of cells 102 in the battery pack 100 to facilitate efficient and effective cell 102 management and maintenance. For example, during battery pack 100 operation, if one or more of the modules 110 become inoperable and are turned off, the overall power output of the battery pack 100 is not significantly affected. The modules 110 are preferably arranged into a triangle within the battery pack 100 to conserve space and to form a triangular foundation for the battery pack 100, as shown in FIGS. 5 and 6. The modules 110 may, however, be arranged with any suitable arrangement.

The endplates 130 of the preferred embodiment, which are preferably placed at either end of the pack of modules 110, function to integrate the mechanical, electrical, and thermal interfaces of the modules 110. The endplates 130 preferably include a plurality of mounting terminals that function to hold individual modules 110 in place while providing reliable connections with the electrical and thermal management systems.

### 3.1 Mechanical Management

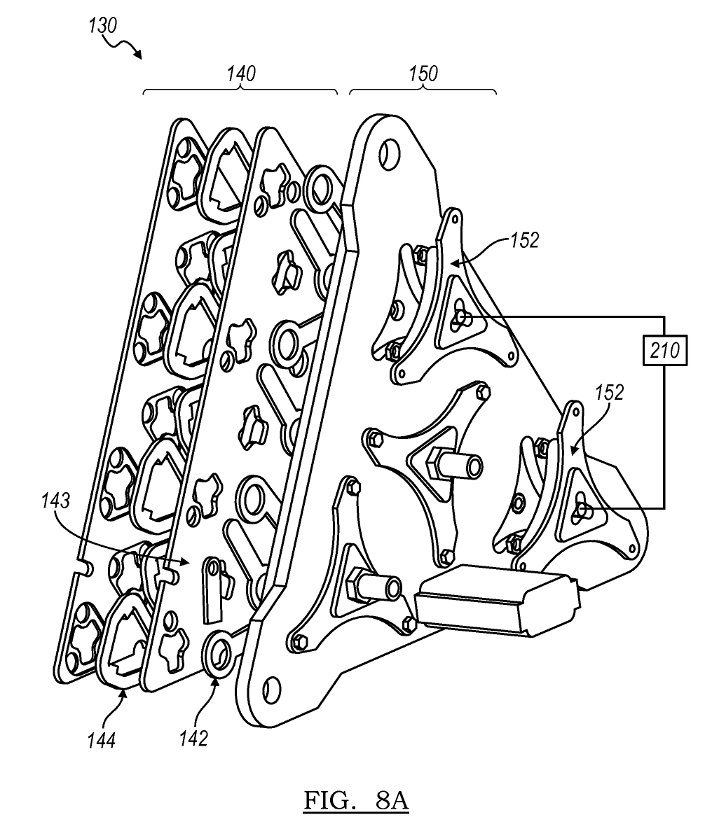

As shown in FIG. 7, the preferred embodiment of the battery pack 100 includes a non-permanent locking mechanism 111 to mechanically engage each module 110 in the battery pack 100. The locking mechanism preferably provides equal mechanical holding to each module 110 at each mounting terminal. Alternatively, the battery pack 100 may include a plurality of locking mechanisms that each engage with a portion of the total modules 110 in the battery pack 100 at the mounting terminals. This plurality of locking mechanisms 111 may facilitate the removal of some but not all of the modules 110 when necessary (for example, during maintenance or rearrangement of modules 110). The mounting terminals on the endplate 130 preferably have a shape or mechanism that facilitates mounting of the module 110 to the endplate 130, such as a slot or fitted geometry. The locking mechanism 111 preferably accommodates to the geometric symmetry of the modules 110 to allow modules 110 to be arranged in any orientations that best optimizes performance. For example, this mechanism may consist of a circular hole in the endplate 130 that interfaces circular geometry on the module 110. The circular geometry on the module 110 may include threads that are used to secure the module 110 to the endplates 130 through the use of a nut. Alternatively, because the module 110 is triangularly symmetric, the mechanical lock lit may have a triangular female connector that allows the module 110 to be oriented in any of three symmetric orientations while preventing excessive rotation or movement of the module 110. In the variation with one locking mechanism 111 providing equal mechanical holding to each module 110, latches may be used to pull the two endplates 130 toward each other to secure the modules 110 within. Alternatively, the endplates 130 may be fastened to long rod stand-offs to pull the endplates 130 toward each other. However, any other suitable locking mechanism may also be used. In the variation with a plurality of locking mechanisms 111, each module connector may be equipped with a spring-loaded latch that engages a ridge in the module 110. Alternatively, the locking mechanism 111 may also include other mechanically stabilizing elements such as bolts that interface directly with the module 110. In other words, the modules 110 may also function to pull the endplates 130 toward each other. To prevent shock from directly transferring from the endplate 130 to the individual modules 110, a shock absorption system may also be included into the locking mechanism. This is preferably a material with high shock absorption capability such as foam, but may alternatively be a dynamic mechanical element such as a spring. However, any other suitable material or mechanical element may be used. The mounting terminals for each module 110 are preferably similar such that the modules 110 can be interchanged and mounted on whichever terminal that best optimizes performance. For example, a module 110 that has a tendency to overheat may be located closer to the perimeter of the battery pack 100 to decrease thermal influence from other modules 110 in the battery pack 100. Alternatively, the terminals may be adapted to fit specific types of modules 110 that may have designed for optimal performance at particular locations within the battery pack 100.

The battery pack 100 of preferred embodiments preferably also includes a casing (not shown) that encases the battery pack 100 and/or the modules 110 within the battery pack 100. The casing functions as a seal, to provide a closed environment and keep contamination from entering the battery pack 100. The casing may also function to provide a hermetic seal around the modules 110. The casing may also cooperate with the endplate 130 to form the hermetic seal. The casing is preferably made of sheet metal that is formed to connect with the endplates 130 to form a unified structural support structure to protect the internal battery modules 110. Alternatively, the casing may be made of several pieces that interlock to form the casing. The casing and endplate 130 assembly is preferably non-permanent on both endplates 130 to facilitate maintenance and repair of the battery modules 110, but alternatively may be a permanent assembly to one endplate 130 and non-permanent to the second endplate 130 to allow access to the battery modules 110 within the battery pack 100. The casing is preferably symmetric, but may alternatively contain asymmetric orientation features that facilitate identification of battery packs 100. To further seal the modules 110, a reusable sealing material such as rubber may also be placed around the interface between the casing and the endplates 130 to provide a hermetic and waterproof seal. Alternatively, sealant may be applied post-casing assembly to provide a similar seal. This sealant is preferably re-applied when any of the endplates 130 are detached from the casing and re-attached (for example, during maintenance). However, any other suitable sealing method or material may be used.

The general structure and arrangement of the battery pack 100 and modules 110 preferably avoids joining cells 102 and modules 110 with permanent glues and fixations, providing ease of maintenance and repair. Alternatively, to provide rigidity and structural stability to the battery pack 100, the ductor 120 of the module 110 may be permanently fixated to one endplate 130 while remaining detachable from the remaining endplate 130 to enable cell 102 maintenance.

### 3.2 Electrical Management

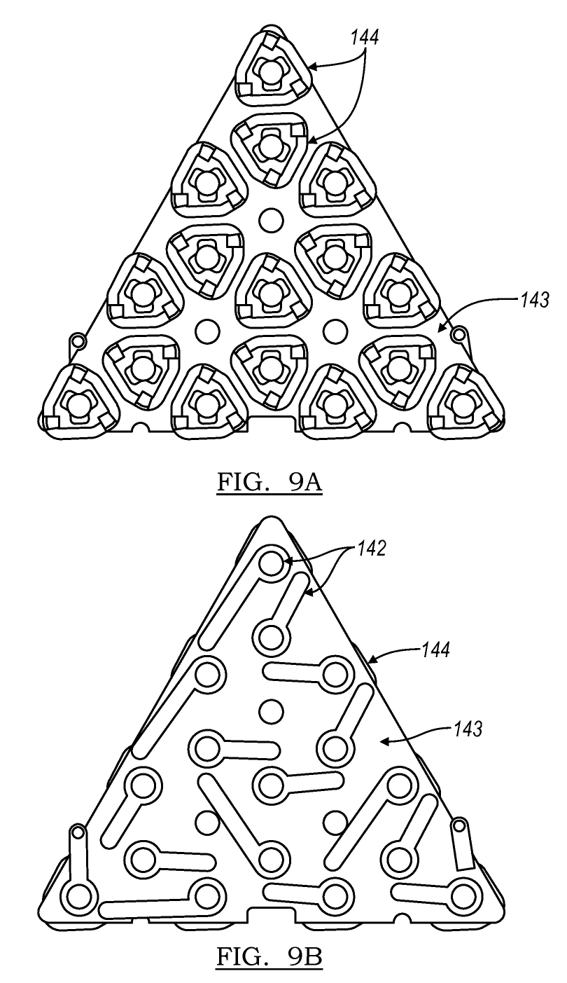

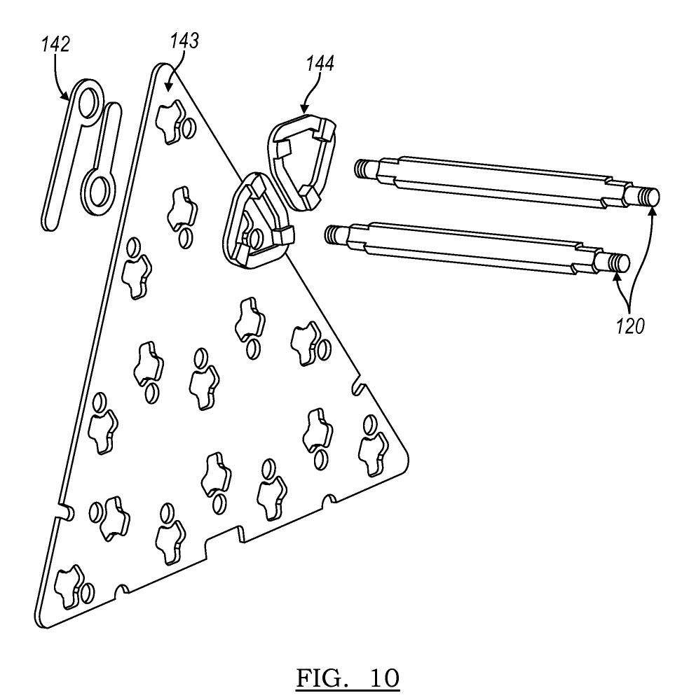

As shown in FIGS. 8-10, the endplate 130 of the preferred embodiments includes electrical interfaces to each module 110 at the mounting terminals on the endplate 130 that are preferably isolated from the fluid interfaces and any mechanical loading that the battery pack 100 may experience. The electrical interface are preferably in the form of a plug for easy mounting of the module 110, but may alternatively be contacts that connect with the module 110 upon assembly or any other suitable electrical interface. The endplates 130 of the preferred embodiments also include integrated battery management circuitry, and electrical turn-around contacts that function to electrically connect the modules 110 within the battery pack 100. The endplates 130 also include external mounting points for the overall battery pack 100, including main electrical positive (+) and negative (−) connections that allow the battery pack 100 to function as a stand-alone unit and to connect with the electrical circuit managed by the electrical management system.

The endplates 130 preferably include a central processing unit that functions to receive the operating conditions of each module 110 and evaluate the conditions relative to other operating data, for example, power output necessary, ambient temperature, historical battery pack usage behavior, module behavior relative to location in the battery pack, etc. The central processing unit may further function to store historical operating conditions for each module 110 that may be useful in predicting future events such as module failure, module behavior based on conditions of neighboring modules, or necessary maintenance. In addition, the central processing unit is preferably capable of using the stored historical and real time data to determine battery pack optimization, for example, determining which modules might function better when placed in close proximity, which modules may potentially damage neighboring modules and should be disconnected from the battery pack structure, etc. As mentioned in the detailed description of the module level 110, the modules 110 may include sensors and processors that are able to monitor operating conditions to determine if the module 110 should stay connected, disconnect, or reconnect to the battery pack 100. Because the central processing unit possesses a general system view of the battery pack 100, it is preferably able to override the mode determination carried out by the processor of each module 110 if necessary. The battery pack 100 may also include sensors that monitor the overall conditions within the battery pack 100, for example, the overall voltage output, the overall temperature, the overall resistance, and/or the overall pressure within the battery pack 100. The sensors may also include an accelerometer that functions to detect rapid accelerations of the battery pack 100, which may indicate mishandling of the battery pack 100 (such as falling or a vehicle crash), which may cause harm to the battery pack 100, the device, or the user. When such an event is detected, the battery pack 100 may disconnect from the system to protect the battery pack 100, the device, and/or the user. This multi-level cell management facilitates intelligent continuous optimization of the entire battery pack 100. The central processing unit may also function to determine whether the battery pack 100 should be connected, be disconnected, or be reconnected to the electrical circuit managed by the electrical management system based upon the detected conditions within the battery pack 100. For example, in the variation of the battery pack 100 that is hermetically sealed, the central processing unit may detect a substantial increase in pressure within the battery pack 100 from catastrophic failure of a module 110 or a cell 102 and determine to disconnect the battery pack 100 from the electrical circuit.

The central processing unit of the endplates 130 may further function to connect some but not all of the healthy modules 110 within the battery pack 100 such that some modules 110 (known as the “back up” modules) are connected when other modules 110 (known as the “main” modules) become unhealthy and unfit to function. This allows for level power output to be produced by the battery pack 100 at all times. Alternatively, the central processing unit may determine the optimized usage cycle for each module 110 based upon stored historical data. For example, certain modules 110 may have an optimal power charge/discharge cycle that is different from other modules 110 in the battery pack 100. The central processing unit determines the power charge/discharge characteristics that best extend the life of the module 110 and then directs optimized electrical loading to that particular module 110 during the usage cycle of the battery pack 100.

The preferred embodiment also includes safety mechanisms that function to prevent accidental electrical contact with the ambient environment. The safety mechanism may include, for example, a sensor to sense a loose lock mechanism in the battery pack 100 during a usage cycle and, upon such sensing, trigger safety warnings or shut down of the battery pack 100. In another example, the lock mechanism in the battery pack 100 can be controlled by an electrical system that requires authorization before the lock mechanism can be released, preventing inexperienced users from tampering with a high potential battery pack 100. In yet another example, when used in a vehicle, the central processing unit will receive and monitor vehicle operating conditions such that in the event of a crash, electrical power can be disconnected to prevent danger to the rider or rescue workers.

The mechanical casing of the preferred embodiment also functions to provide electrical confinement to the battery pack 100. Battery pack 100 electrical confinement is coupled with module 110 electrical confinement to potentially improve the ability to contain heat and fire in the event of a cell catastrophic failure.

### 3.3 Thermal Management

As mentioned above, the thermal management system of the battery pack 100 preferably includes a source 210 of thermally conductive fluid and preferably manages the thermal conditions within the battery pack 100. The thermal management system may also include means for heat dissipation, heat sourcing, and fluid pumping. The endplates 130 each include at least one fluid connection to the fluid source 210 of the thermal management system and a fluid connection for each of the individual modules 110.

The thermal management system preferably includes at least one temperature probe dedicated to each individual module 110. Alternatively, the operating temperature of the cells 102 can be predicted from voltage, current, and internal resistance measurements of the cells 102. The central processing unit processes temperature information and factors this information into evaluation of overall battery pack optimization.

The mounting terminals of the preferred embodiment also include sealing elements to optimize the thermal fluid flow through the module 110. Preferably, o-rings are assembled in the mounting terminal of the endplate 130. Alternatively, a waterproof sealant may be applied to the interface between the module 110 and the endplate 130. However, any other means or materials capable of sealing fluid may be used.

As mentioned in the detailed description of the preferred embodiment of the module 110, the external thermal management system preferably includes a pump that is capable of driving fluid through the modules 110 to extract heat generated by the cells 102 or to import heat from a heat source 210 to the cells 102 to maintain the optimal operating temperature for the cells 102. The pump is preferably capable of providing the pressure necessary to pump fluid through the conduit in the ductor 120 of the module 110 at a desired rate for the appropriate heat transfer.

The thermal management system preferably provides equal heat transfer to the cells 102, but alternatively may also be directed at different flow rates or volumes to provide more cooling or heating to cells 102 based on individual cell 102 operating conditions. To provide different flow rates or volumes, the endplates 130 may include valves that have variable diameter and can allow different volumes of fluid through at one time. The central processing unit preferably controls the valves and determines valve settings based upon evaluations of stored historical and real time system data.

### 3.4 Endplate Interface Integration

As shown in FIGS. 8a and 8b, the endplate 130 preferably includes an electrical layer 140 and a fluid layer 150. The electrical layer 140 functions to integrate the cells 102 of the modules 110 within the battery pack 100 with the electrical circuit managed by the electrical management system. The fluid layer 150 functions to integrate the ductors 120 of each module 110 within the battery pack 100 to the external thermal management system. The electrical layer 140 and the fluid layer 150 cooperate to allow each mounting terminal in the endplate 130 of the battery pack 100 to provide the necessary electrical and fluid connections to each module 110 in the battery pack 100.

As shown in FIGS. 8-10, the electrical layer 140 preferably consists of positive electrical contacts 144 for the positive (+) terminals of each cell 102 in the module 110 and negative electrical contacts 142 for each ductor 120, which serves as the collective negative (−) terminal for each cell 102 in the module 110. An electrical insulator 143 is preferably placed between the positive (+) and negative (−) contacts 144 and 142 to provide controlled contact points between the positive (+) and negative (−) contacts 144 and 142 and mechanically hold the positive (+) and negative (−) contacts 144 and 142 in the desired locations. The electrical insulator 143 is preferably an insulating material such as Nomex, aramid, or any other suitable type of insulating material, that is stamp cut to contain the necessary features. Alternatively, the electrical insulator 143 may also be an insulating material that is injection molded to contain the necessary features. However, any other suitable material may be used. Alternatively, the positive (+) and negative (−) contacts 144 and 142 may be embedded into the printed circuit board, eliminating the need for assembly and the electrical insulator. The modules 110 are preferably connected in series within the battery pack 100. Each positive contact 144 from one module 110 is preferably connected to the negative contact 142 for the following module 110 in the series, which completes the electrical connection between each module 110. The electrical layer 140 also includes a printed circuit board that includes contacts to individual modules 110 and the electrical path for the combined potential of the battery pack 100. The contacts to individual modules 110 allow the integrated circuitry to monitor conditions local to each module 110, for example, current, voltage, etc. One contact point for the electrical path for the combined potential of the battery pack 100 is preferably located at the beginning of the series connection and the other is preferably located at the end of the series connection. The integrated circuitry on the printed circuit board may also function to regulate the power output of the battery pack 100. This regulated output is preferably provided to the device through the use of a secondary electrical output path contact that is preferably insulated from the main electrical path and from the module 110 positive (+) and negative (−) electrical contacts.

As shown in FIGS. 8a and 8b, the fluid layer 150 preferably consists of a fluid flow director, a mechanical connection to the ductor 120, and a sealant that isolates the fluid layer 150 from the electrical layer 140. The fluid flow director preferably includes an inlet and an outlet of either a first or a second variation 152 or 154. As mentioned above, each battery pack 100 preferably includes two endplates 130. The first endplate 130 preferably includes the fluid flow director of the first variation 152 and the second endplate 130 preferably includes the fluid flow director of the second variation 154. Alternatively, each of the first and second endplates 130 may include a fluid flow director of the first variation. However, any other suitable combination of the first and second variations of the fluid flow directors may be used.

As shown in FIG. 8a, the fluid flow director 152 of the first variation consists of at least one inlet coupled to the fluid source 210 and at least one outlet and directs fluid from the fluid source 210 into a module 110. The first variation of the fluid flow director 152 may include more fluid outlets than fluid inlets, hereafter known as the “fluid disperser 152.” Each fluid outlet is associated with a channel 122 of a module 110 within the battery pack 100 and the fluid flow director directs fluid from the fluid inlets into each of the associated channels 122. The first variation of the fluid flow director 152 may also include more fluid inlets than outlets, hereafter known as the “fluid collector 152.” Each fluid inlet is associated with a channel 122 of a module 110 within the battery pack 100 and the fluid flow director directs fluid flowing out from the associated channels 122 into a fluid outlet that gathers the fluid. The fluid disperser and the fluid collector are preferably similar or substantially identical in geometry. The fluid disperser and the fluid collector are preferably coupled to the fluid source 210 through piping that is preferably flexible to allow for flexible arrangement of the battery pack 100. However, any other suitable material or method may be used to couple the fluid disperser/collector to the fluid source 210.

As shown in FIG. 8b, the fluid flow director functions of the second variation 154 to redirect flow from a first module 110 to a second module 110, hereafter known as the “fluid turn-around cap 154.” The fluid inlet of the second variation is coupled to the channel 122 of the first module 110 and the fluid outlet of the second variation is coupled to the channel 122 of the second module 110. The fluid turn-around cap 154 may also redirect flow from one set of modules 110 through to a second set of modules 110. The fluid flow from a set of modules 110 that include more than one module 110 may be collected through a fluid collector as described above and then directed to the fluid turn-around cap 154. Alternatively, the fluid turn-around cap 154 may include a geometry that overlaps a plurality of channels 122 and function to collect the fluid flow from the plurality of modules 110. However, any other suitable method to collect fluid from multiple modules 110 to a fluid turn-around cap 154 may be used. Because the modules 110 are connected in series, there may be a significant difference in potential of the first module 110 in the series and the last module 110 in the series. For example, if each module 110 is at 4 volts and the first module 110 is connected with ground (0 volts), the first module 110 provides a 4 volt increase to the next module 110 in series, resulting in the next module 110 having a virtual ground at 4 volts and providing another 4 volt increase. If there are 16 modules 110 in series, there will be a total of a 64 volt increase from the first module 110 to the last. To minimize negative effects such as corrosion of the ductors 120 that may result from the thermal fluid flow path traversing through a significant voltage potential difference through the modules 110, there are preferably two flow paths through the modules 110. Each flow path preferably traverses through one half of the modules 110 to provide equal treatment to all modules 110. In the previous example, the first flow path will preferably flow through the first 8 modules 110, resulting in a 0 volt to 32 volt voltage potential difference for the flow path, while the second flow path will preferably flow through the second 8 modules no, resulting in a 32 volt to 64 volt voltage potential difference for the flow path. Both flow paths effectively have the same potential difference from start to finish.

An example of a battery pack 100 includes two endplates 130, each with fluid flow directors of the first variation 152. The fluid flow director on the first endplate 130 functions to take fluid from the thermal management system and to split the fluid into four portions to flow through four modules 110 at a relatively similar flow rate and provide relatively similar thermal benefits to each module 110. Alternatively, based on the performance of the module 110, the fluid inlet may be designed to allow a larger volume of fluid flow through certain modules 110. The fluid flow director on the second endplate 130 preferably functions to take fluid that has been through the modules 110 in battery pack 100 and return the fluid to thermal management system.

A second example of a battery pack 100 includes a first endplate 130 that includes two fluid dispersers 152, each with one fluid inlet and four fluid outlets, and two fluid collectors 152, each with four fluid inlets and one fluid outlet, and a second endplate 130 that includes at least two fluid turn-around caps 154. The fluid disperser and the fluid collector function to disperse fluid to four modules 110 and to collect fluid from four modules 110, respectively. The fluid disperser 152 preferably disperses the fluid substantially equally into all four modules 110, but may alternatively provide a larger volume of fluid flow to optimize module 110 performance. The fluid turn-around caps 154 serve as a channel 122 for fluid that has been directed through a set of four modules 110 to continue onto another set of four modules 110. Each of the fluid collectors and dispersers 152 preferably function equally well as both a collector and a disperser, facilitating flow of fluid through the system in both forward and backward directions.

The second example of the battery pack 100 allows for two concurrent flows of fluid through the battery pack 100 at one time. Each flow preferably traverses through four modules 110 before turning around and traversing through another four modules 110, traversing through a total of eight modules 110 each for a total of sixteen modules 110. In each flow, the second set of four modules 110 receive fewer thermal benefits than the first set of four modules 110 due to the heat transfer that occurred between the fluid and the first set of four modules 110 that has decreased the temperature difference between the module 110 and the fluid. To offset the unbalanced thermal benefits between the modules 110, the flow direction is preferably switched after a set time or number of cycles. This may help equalize the thermal benefits received by each module 110. Alternatively, fluid flow rate may be regulated to achieve a similar effect. For example, as the fluid traverses through the first set of four modules no, the fluid flow rate may be increased to regulate the heat transferred to or from the volume of fluid and subsequently, as the fluid traverses through the second set of four modules 110, the flow rate may be decreased to allow a similar amount of heat transfer to or from the fluid that now has a smaller temperature difference with the module 110. However, any other suitable method of equalizing thermal benefit throughout the modules 110 in the battery pack 100 may be used.

The mechanical connection of the fluid layer 150 functions to provide a reliable mechanical connection between the module 110 and the endplate 130. This is preferably a mounting location that accommodates to a threaded section of the ductor 120 and allows a nut or some other fastening component to be used to secure the ductor 120. Alternatively, it may be of any material, method, or mechanism as described in the Mechanical Management section above or any other suitable material, method, or mechanism.

The sealant of the fluid layer 150 functions to prevent any fluid leakage into the electrical layer 140. This is preferably accomplished using an o-ring that seals the interface between the ductor 120 and the mechanical connection. Alternatively, it maybe of any material, method, or mechanism as described in the Thermal Management section above or any other suitable material, method, or mechanism.

As a person skilled in the art will recognize from the previous detailed description and from the figures and claims, modifications and changes can be made to the preferred embodiments of the invention without departing from the scope of this invention defined in the following claims.

We claim:

1. A multi-cell battery pack system with integrated thermal and electrical management, comprising:
a plurality of cells;
a plurality of cradles, each defining a channel that extends through the length of the cradle and having an external surface that mechanically positions each of the cells radially around and parallel to the channel, that exchanges heat with the cells and that electrically couples with each of the cells; and
an endplate that mechanically couples to each cradle;
wherein the mechanical coupling of the cradle with the endplate connects the channel of the cradle to a fluid circuit that routes thermally conductive fluid through the channel to exchange heat with the channel and connects the cells to an electrical circuit.

2. The system of claim 1, wherein each of the plurality of cells is a cylindrical cell having a rounded side surface and two opposing end surfaces.

3. The system of claim 2, wherein each of the plurality of cradles exchanges heat with the cells by extending about the rounded surface in a circumferential direction and substantially extending between the two opposing end surfaces in an axial direction.

4. The system of claim 1, wherein the cradle positions the cells radially equidistant from the channel.

5. The system of claim 1, wherein the electrical circuit electrically couples the cradles in a series configuration.

6. The system of claim 5, wherein the fluid circuit routes a first stream of fluid through a portion of the channels in the battery pack system to exchange heat with the channels, wherein the voltage potential difference from the beginning to end of the first fluid stream is less than the total voltage potential difference of the series configuration; and wherein the fluid circuit routes a second stream of fluid through another portion of channels in the battery pack system to exchange heat with the channels, wherein the voltage potential difference from the beginning to end of the second fluid stream is less than the total voltage potential difference of the series configuration.

7. The system of claim 6, wherein the voltage potential difference from the beginning to end of the first fluid stream is substantially equal to the voltage potential difference from the beginning to end of the second fluid stream.

8. The system of claim 1, further comprising a casing that envelopes the plurality of cradles.

9. The system of claim 8, wherein the casing forms a hermetic seal encasing the plurality of cradles.

10. The system of claim 8, wherein the casing is mechanically coupled to the end plate.

11. The system of claim 10, wherein the mechanical couple between the end plate and the casing includes a hermetic seal.

12. The system of claim 1, further comprising a processor.

13. The system of claim 12, further comprising a sensor, wherein the sensor is electronically coupled to the processor and the processor receives sensor data from the sensor.

14. The system of claim 13, wherein the sensor is of a type selected from the group consisting of: voltage sensor, current sensor, and temperature sensor.

15. The system of claim 13, wherein the sensor is a pressure sensor.

16. The system of claim 13, wherein the sensor is an accelerometer.

17. The system of claim 13, wherein the processor disconnects a cradle from the electrical circuit based upon sensor data.

18. The system of claim 1, wherein the cradle is mechanically coupled to the endplate with a fastener selected from the group consisting of: screw, adhesive, latch, and mating geometry.

19. The system of claim 18, wherein the fastener fixedly couples the cradle to the endplate.

20. The system of claim 1, wherein the endplate includes a fluid layer and an electrical layer.

21. The system of claim 20, wherein the endplate further includes an insulator that is placed in between the fluid layer and the electrical layer.

22. The system of claim 20, wherein the electrical layer includes a positive electrical sublayer and a negative electrical sublayer and an electrical insulator that is placed in between the positive electrical sublayer and the negative electrical sublayer.

23. The system of claim 20, wherein the fluid layer includes a fluid flow director that includes a fluid inlet and a fluid outlet.

24. The system of claim 23, further including a fluid source and wherein the fluid inlet is coupled to the fluid reservoir.

25. The system of claim 23, wherein the fluid flow director includes more fluid outlets than fluid inlets, wherein each fluid outlet is associated with a channel of a cradle and the fluid flow director directs flow from the inlets into each of the associated channels.

26. The system of claim 25, wherein the fluid flow director directs substantially equal volume of flow into each of the associated channels.

27. The system of claim 23, wherein the fluid inlet is coupled to a first channel and the fluid outlet is coupled to a second channel, and the fluid flow director directs fluid from the first channel to the second channel.

28. The system of claim 1, further including a second endplate, wherein the channel of the cradle includes a first end and a second end, wherein the endplate is mechanically coupled to the first end of the channel and the second endplate is connected to the second end of the channel.

29. The system of claim 28, wherein the second endplate is substantially identical to the endplate.

30. A method for thermally, electrically, and mechanically managing a battery pack system comprising the steps of:
providing an electrically conductive and thermally conductive cradle defining a channel;
mechanically coupling a plurality of cells radially around the channel of the cradle;
allowing the power source to exchange heat and conduct electricity through the mechanical coupling to the cradle;
providing an endplate;
routing a circuit of thermally conductive fluid to the endplate;
routing an electrical circuit to the endplate;
mechanically coupling the cradle to an endplate, wherein mechanically coupling the cradle to the endplate connects the channel to the fluid circuit and connects the cells to the electrical circuit.

31. A method for thermally managing a battery pack system comprising the steps of:
electrically coupling a plurality of power sources into a series configuration;
thermally coupling each cell to a channel that exchanges heat with the power source;
routing a first stream of fluid through a portion of the channels in the battery pack system to exchange heat with the channels, wherein the voltage potential difference from the beginning to end of the first fluid stream is less than the total voltage potential difference of the series configuration; and
routing a second stream of fluid through another portion of channels in the battery pack system to exchange heat with the channels, wherein the voltage potential difference from the beginning to end of the second fluid stream is less than the total voltage potential difference of the series configuration.

32. The method of claim 31, wherein the voltage potential difference from the beginning to end of the first fluid stream is substantially equal to the voltage potential difference from the beginning to end of the second fluid stream.

33. The method of claim 31, further comprising the step of arranging a plurality of cells into each power source.

34. The method of claim 33, further comprising the step of electrically coupling each of the cells in each battery group into a parallel configuration.
